(19) United States
(12) Patent Application Publication
(10) Pub. No.: US 2013/0133805 A1
(43) Pub. Date: May 30, 2013

(54) PNEUMATIC TYRE, THE BELT OF WHICH IS PROVIDED WITH A COATING RUBBER THAT REDUCES ROLLING NOISE

(71) Applicants: Salvatore Pagano, Chiyoda-ku (JP); Mitsue Tanaka, Gunma (JP)

(72) Inventors: Salvatore Pagano, Chiyoda-ku (JP); Mitsue Tanaka, Gunma (JP)

(73) Assignees: MICHELIN RECHERCHE ET TECHNIQUE S.A., GRANGES-PACCOT (CH); COMPAGNIE GENERALE DES ETABLISSEMENTS MICHELIN, CLERMONT-FERRAND (FR)

(21) Appl. No.: 13/701,979

(22) PCT Filed: May 24, 2011
(86) PCT No.: PCT/EP11/58443

§ 371 Date: Feb. 14, 2013

(30) Foreign Application Priority Data
Jun. 17, 2010 (FR) 1054829

(51) Int. Cl. B60C 1/00

(52) U.S. Cl. CPC B60C 1/00
USPC 152/537

(57) ABSTRACT

A radial tyre for motor vehicle includes: a crown with at least a tread and a crown reinforcement or belt, two inextensible beads, two sidewalls connecting the two inextensible beads to the tread, and a carcass reinforcement passing into the two sidewalls and anchored in the two inextensible beads. The belt is positioned circumferentially between the tread and the carcass reinforcement, and includes textile or metallic reinforcers coated with a rubber composition referred to as a “belt-coating rubber.” The belt-coating rubber, which is capable of reducing the tyre's rolling noise, includes a diene elastomer and more than 50 phr of a filler of high-density particles having a density of greater than 4 g/cm³.

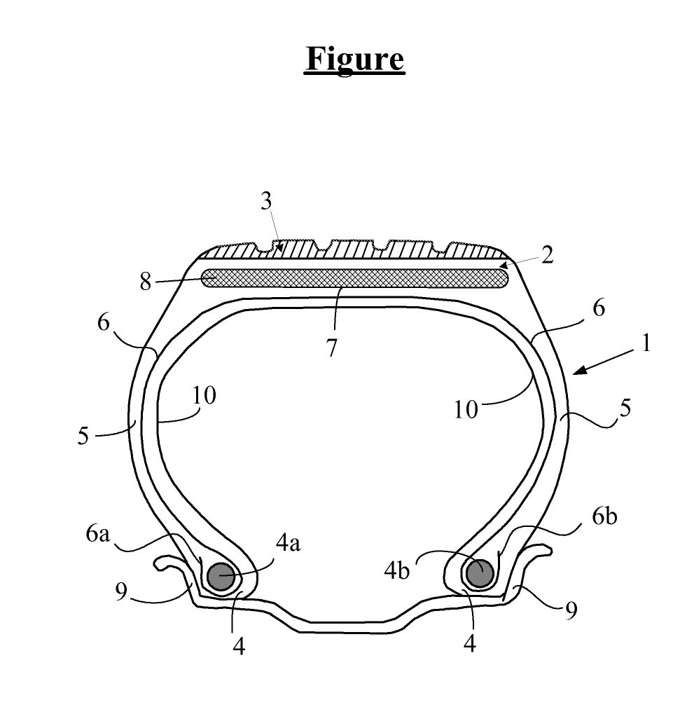

### 1. FIELD OF THE INVENTION

The invention relates to tyres for motor vehicles and to the crown reinforcements, also referred to as “belts”, of these tyres, and also to rubbery compositions that can be used for the manufacture of such tyres.

It relates more particularly to the rubbery compositions used in the crown of tyres having a radial carcass reinforcement for reducing the noise emitted when these tyres are rolling.

### 2. PRIOR ART

It is known that the noise emitted by a tyre when rolling originates, inter alia, from the vibrations of its structure following contact of the tyre with the uneven roadway, also giving rise to a generation of various sound waves. This is all ultimately manifested in the form of noise, both inside and outside the vehicle. The amplitude of these various manifestations is dependent on the modes of vibration characteristic of the tyre but also on the nature of the surface on which the vehicle is moving. The range of frequencies corresponding to the noise generated by the tyres typically extends from 20 to 4000 Hz approximately.

As regards the noise detected inside the vehicle, two modes of sound propagation coexist:
the vibrations are transmitted by the wheel centre, the suspension system and the transmission ultimately generating noise in the passenger compartment; this is then referred to as solid-borne transmission, which is generally dominant for the low frequencies of the spectrum (up to approximately 400 Hz);
the sound waves emitted by the tyre are directly propagated by an airborne route inside the vehicle, the latter serving as a filter; this is then referred to as airborne transmission, which generally dominates in the high frequencies (approximately 600 Hz and above).

The noise referred to as “road noise” refers rather to the overall level detected in the vehicle and in a frequency range extending up to 2000 Hz. The noise referred to as “cavity noise” refers to the disturbance due to the resonance of the inflation cavity of the tyre cover.

As regards the noise emitted outside the vehicle, the various interactions between the tyre and the road surface, and the tyre and the air are relevant, which will give rise to a disturbance for local residents when the vehicle is running along a roadway. In this case several sources of noise are also distinguished such as the noise referred to as “indentation noise” due to the impact of the roughness of the road in the contact area, the noise referred to as “friction noise” essentially generated at the end of the contact area, the noise referred to as “tread pattern noise” due to the arrangement of the tread pattern elements and to the resonance in the various grooves. The range of frequencies relative to these external noises typically corresponds here to a range extending from 300 to 3000 Hz approximately.

### 3. BRIEF DESCRIPTION OF THE INVENTION

However, the Applicant companies have discovered, during their research, a specific rubber composition that, used as a coating rubber for the (textile and/or metallic) reinforcers of the belt of the tyres, has improved sound-barrier properties within a frequency range lying between 500 and 2000 Hz, and which is therefore capable of helping to reduce the noises emitted both inside and outside vehicles when the tyres are rolling.

Consequently, a first subject of the invention relates to a radial tyre for a motor vehicle, comprising:
a crown (2) comprising a tread (3) and a crown reinforcement or belt (7);
two inextensible beads (4), two sidewalls (5) connecting the beads (4) to the tread (3), a carcass reinforcement (6) passing into the two sidewalls (5) and anchored in the beads (4);
the crown reinforcement or belt (7) placed circumferentially between the tread (3) and the carcass reinforcement (6), comprising textile or metallic reinforcers coated with a rubber composition referred to as a “belt-coating rubber”,
   this tyre being characterized in that the belt-coating rubber comprises at least a diene elastomer, and, as a high-density filler, more than 50 phr particles referred to as high-density particles having a density of greater than 4 g/cm³.

The tyres of the invention are particularly intended to be fitted on passenger type motor vehicles, including 4×4 (four-wheel drive) vehicles and SUV vehicles (“Sport Utility Vehicles”), two-wheel vehicles (especially motorcycles), and also industrial vehicles chosen in particular from vans and heavy-duty vehicles (i.e., underground trains, buses, heavy road transport vehicles such as lorries, tractor units and trailers, off-road vehicles such as agricultural or civil-engineering vehicles).

The invention relates to the above tyres both in the uncured state (i.e., before curing) and in the cured state (i.e., after crosslinking or vulcanization).

The invention and its advantages will be readily understood in light of the description and exemplary embodiments that follow, and also the single FIGURE relating to these embodiments which schematically shows, in radial cross section, an example of a radial tyre in accordance with the invention.

### 4. DETAILED DESCRIPTION OF THE INVENTION

In the present description, unless expressly indicated otherwise, all the percentages (%) indicated are % by weight.

The abbreviation “phr” signifies parts by weight per hundred parts of elastomer or rubber (of the total of the elastomers if several elastomers are present).

Moreover, any interval of values denoted by the expression “between a and b” represents the range of values going from more than a to less than b (i.e., the limits a and b excluded) whereas any interval of values denoted by the expression “from a to b” means the range of values going from a to b (i.e., including the strict limits a and b).

The tyre of the invention therefore has the essential feature of being provided with a belt or crown reinforcement, the textile and/or metallic reinforcers of which are embedded in an elastomer composition or specific coating rubber (referred to as a belt-coating rubber) which comprises at least a diene elastomer and, as a high-density filler, more than 50 phr of particles referred to as high-density particles the density of which is greater than 4 g/cm³, optionally a reinforcing filler and other optional additives, which components will be described in detail below.

### 4.1.—Formulation of the Belt-Coating Rubber

### 4.1.A. Diene Elastomer

Diene elastomers may be classified, in a known manner, into two categories: those said to be “essentially unsaturated” and those said to be “essentially saturated”. For example, butyl rubbers or diene/α-olefin copolymers of the EPDM type fall under the category of essentially saturated diene elastomers, having a low or very low content of units of diene origin, always less than 15% (mol %). A contrario, the expression “essentially unsaturated diene elastomer” is understood to mean a diene elastomer resulting at least partly from conjugated diene monomers, having a content of units of diene origin (conjugated dienes) that is greater than 15% (mol %). In the “essentially unsaturated” diene elastomer category, the expression “highly unsaturated diene elastomer” is understood in particular to mean a diene elastomer having a content of units of diene origin (conjugated dienes) that is greater than 50%.

It is preferred to use at least one diene elastomer of the highly unsaturated type, in particular a diene elastomer selected from the group consisting of polybutadienes (BRs) (especially those having a content of cis-1,4-bonds of greater than 90%), synthetic polyisoprenes (IRs), natural rubber (NR), butadiene copolymers, isoprene copolymers (other than IIR) and mixtures of these elastomers. Such copolymers are more preferably selected from the group consisting of butadiene/styrene copolymers (SBRs), isoprene/butadiene copolymers (BIRs), isoprene/styrene copolymers (SIRs), isoprene/butadiene/styrene copolymers (SBIRs) and mixtures of such copolymers.

The elastomers can, for example, be block, random, sequential or microsequential elastomers and can be prepared in dispersion or in solution; they can be coupled and/or star-branched or else functionalized with a coupling and/or star-branching or functionalizing agent. For coupling with carbon black, mention may be made, for example, of functional groups comprising a C—Sn bond or of aminated functional groups, such as benzophenone, for example; for coupling with a reinforcing inorganic filler such as silica, mention may be made, for example, of silanol functional groups or polysiloxane functional groups having a silanol end (as described, for example, in U.S. Pat. No. 6,013,718), of alkoxysilane groups (as described, for example, in U.S. Pat. No. 5,977,238), of carboxylic groups (as described, for example, in U.S. Pat. No. 6,815,473 or US 2006/0089445) or else of polyether groups (as described, for example, in U.S. Pat. No. 6,503,973). Mention may also be made, as other examples of functionalized elastomers, of the elastomers (such as SBR, BR, NR or IR) of the epoxidized type.

According to one particularly preferred embodiment of the invention, the diene elastomer is selected from the group consisting of natural rubber, synthetic polyisoprenes, polybutadienes having a content of cis-1,4-bonds of greater than 90%, butadiene/styrene copolymers and mixtures of these elastomers.

The following are preferably suitable: polybutadienes and in particular those having a content of 1,2-units of between 4% and 80% or those having a content of cis-1,4-units of greater than 80%, polyisoprenes, butadiene/styrene copolymers and in particular those having a styrene content of between 5% and 50% by weight and more particularly between 20% and 40%, a content of 1,2-bonds of the butadiene part of between 4% and 65% and a content of trans-1,4-bonds of between 20% and 80%, butadiene/isoprene copolymers and in particular those having an isoprene content of between 5% and 90% by weight and a glass transition temperature (“T_{g}”, measured according to ASTM D3418-82) from −80° C. to −40° C., or isoprene/styrene copolymers and in particular those having a styrene content of between 5% and 50% by weight and a T_{g} of between −50° C. and −10° C. In the case of butadiene/styrene/isoprene copolymers, those having a styrene content of between 5% and 50% by weight and more particularly of between 10% and 40%, an isoprene content of between 15% and 60% by weight and more particularly between 20% and 50%, a butadiene content of between 5% and 50% by weight and more particularly of between 20% and 40%, a content of 1,2-units of the butadiene part of between 4% and 85%, a content of trans-1,4-units of the butadiene part of between 6% and 80%, a content of 1,2-plus 3,4-units of the isoprene part of between 5% and 70% and a content of trans-1,4-units of the isoprene part of between 10% and 50%, and more generally any butadiene/styrene/isoprene copolymer having a T_{g} of between −20° C. and −70° C., are suitable in particular.

According to one particular and preferred embodiment of the invention, the belt-coating rubber comprises, as a diene elastomer, 50 to 100 phr of natural rubber or of a synthetic poly-isoprene, the latter possibly being combined, or not, with a second diene elastomer. This second diene elastomer is preferably selected from the group consisting of polybutadienes, butadiene copolymers and mixtures of these elastomers, in particular from SBR copolymers (solution or emulsion SBRs) more preferably having a T_{g} above −40° C. (in particular in a range from −30° C. to +30° C.) or polybutadienes (BRs) more preferably having a content of cis-1,4-bonds which is greater than 90% (in particular greater than 95%).

According to another more particular and preferred embodiment, the belt-coating rubber comprises, as a diene elastomer, from 50 to 80 phr of natural rubber or synthetic polyisoprene with 20 to 50 phr of an SBR copolymer more preferably having a T_{g} above −40° C. (in particular in a range from −30° C. to +30° C.) or of a polybutadiene (BR) more preferably having a content of cis-1,4-bonds greater than 90%, more preferably still greater than 95%.

According to another particular and preferred embodiment, the diene elastomer used is a ternary mixture of NR (or IR), BR and SBR. Preferably, in the case of such blends, the composition comprises from 40 to 80 phr of NR (or IR) and from 20 to 60 phr of BR and SBR.

Synthetic elastomers other than diene elastomers, or even polymers other than elastomers, for example thermoplastic polymers, may be combined, in a minority amount, with the diene elastomers described above.

### 4.1.B. High-Density Filler

The belt-coating rubber of the tyre of the invention has the essential feature of comprising more than 50 phr, preferably between 50 and 600 phr, of a high-density filler, of which the density of the particles is greater than 4 g/cm³, preferably greater than 4.5 g/cm³, more preferably still greater than 5 g/cm³.

Such high-density fillers are well known to a person skilled in the art of tyres. They have essentially been used to date in tyre treads as a replacement for or in addition to conventional less dense fillers such as silica or carbon black, to attempt to improve some of their usage properties or compromise of properties such as, for example, rolling resistance, wear resistance or grip (see in particular patents U.S. Pat. No. 6,734,245 and U.S. Pat. No. 6,838,495).

The high-density filler used may be in the form of isometric or anisometric particles. It is preferably of micrometre size, i.e., it is in the form of “microparticles”, the size of which is, by definition, greater than one micrometre. Preferably, these microparticles have a median diameter (or a median size if the particles are not essentially spherical), denoted hereinafter by “D”, which is between 1 and 500 μm; more preferably, the median diameter D of the particles is between 2 and 400 μm, in particular between 2 and 200 μm.

The high-density filler is preferably in powder form. According to another preferred embodiment (whether it is in powder form or not), it is in the form of solid particles, but hollow particles or beads of high density could also be used.

The content of the high-density filler is more preferably between 50 and 500 phr. Below the indicated minimum, the targeted technical effect is insufficient, whereas above the recommended maximum, there is a risk of encountering problems of increase in the modulus, of embrittlement of the composition and also filler dispersion and processability difficulties, not to mention a significant degradation of the hysteresis. For all these reasons, this content is more particularly within a range from 70 to 450 phr, most particularly within a range from 100 to 450 phr.

The high-density filler is preferably metallic (that is to say, based on metal or on a metal derivative); it preferably consists of metals such as alkaline-earth metals, transition metals or rare-earth metals, or else derivatives of such metals such as, for example sulphates, carbonates, sulphides, oxides and/or hydroxides, particularly oxides of such metals.

In the case of alkaline-earth metals, mention will be made in particular of barium and strontium. In the case of transition metals, mention will be made in particular of iron, copper, tin, zinc, molybdenum, silver, niobium, tungsten, rhenium, tantalum, hafnium, bismuth, and manganese. Finally, in the case of rare-earth metals, mention will be made in particular of lanthanum, neodymium, cerium or samarium.

More preferably, the metal of the high-density filler, whether it is in the form of a metal or a metal derivative such as an oxide, is selected from the group consisting of iron, copper, tin, zinc, tungsten, bismuth, cerium, neodymium and mixtures of these metals.

These metals and/or metal derivatives, particularly metal oxides, are preferably chosen from those for which the density is greater than 5 g/cm³. As examples of particularly preferred metal oxides, mention may especially be made of those selected from the group consisting of Fe₂O₃ (density 5.1 g/cm³), ZnO (5.7 g/cm³), CuO (6.3 g/cm³), SnO₂ (7.0 g/cm³), WO₃ (7.2 g/cm³), CeO₂ (7.3 g/cm³), Nd₂O₃ (7.2 g/cm³), Bi₂O₃ (8.9 g/cm³) and mixtures of such oxides.

These metal oxides are well known and are available commercially, for example from Nakalai Tesque Inc., Toho Zinc Co., Nihon Kagaku Sangyo Co., Kanto Kagaku, Taiyo Koko Co. and American Elements.

The high-density filler may be introduced into the elastomer composition according to various known processes, for example by compounding in solution, by bulk compounding in an internal mixer, or else by compounding via extrusion.

For the particle size analysis and the calculation of the median diameter of the particles, in particular microparticles, of the high-density filler, various known methods can be applied, for example via laser scattering (for example according to ISO-8130-13 standard or JIS K5600-9-3 standard); it is also possible to simply use a particle size analysis via a mechanical screening through screens of different diameters. The median diameter (or median size) is ultimately calculated in a known manner from the histogram of the particle size distribution.

### 4.1.C. Reinforcing Filler

The belt-coating rubber may also comprise any type of reinforcing filler, known for its ability to reinforce a rubber composition that can be used for the manufacture of tyres, for example an organic filler, such as carbon black, a reinforcing inorganic filler, such as silica with which a coupling agent is, in a known manner, combined, or else a mixture of these two types of filler.

Such a reinforcing filler preferably consists of nanoparticles, the average (weight-average) size of which is less than 1 micrometre, generally less than 500 nm, usually between 20 and 200 nm, in particular and more preferably between 20 and 150 nm.

The density of this reinforcing filler is generally less than 3 g/cm³, in particular less than 2.5 g/cm³.

Preferably, the content of total reinforcing filler (in particular silica or carbon black or a mixture of silica and carbon black) is greater than 20 phr, in particular between 20 and 100 phr. Above 100 phr there is a risk of increasing the hysteresis and therefore the rolling resistance of the tyres. For this reason, the total content of the reinforcing filler is more preferably within a range from 30 to 90 phr.

All carbon blacks conventionally used in tyres or their treads (“tyre-grade” blacks) are suitable as carbon blacks. Mention will more particularly be made, among the latter, of the reinforcing carbon blacks of the 100, 200 or 300 series, or of the blacks of the 500, 600 or 700 series (ASTM grades), such as, for example, the N115, N134, N234, N326, N330, N339, N347, N375, N550, N683 or N772 blacks. The carbon blacks could, for example, already be incorporated in the diene, especially isoprene, elastomer in the form of a masterbatch (see, for example, Applications WO 97/36724 or WO 99/16600).

Mention may be made, as examples of organic fillers other than carbon blacks, of the functionalized polyvinyl organic fillers as described in Applications WO-A-2006/069792, WO-A-2006/069793, WO-A-2008/003434 and WO-A-2008/003435.

The expression “reinforcing inorganic filler” should be understood here to mean any inorganic or mineral filler, whatever its colour and its (natural or synthetic) origin, also known as “white filler”, “clear filler” or sometimes “non-black filler”, in contrast to carbon black, capable of reinforcing by itself alone, without means other than an intermediate coupling agent, a rubber composition intended for the manufacture of tyres, in other words capable of replacing, in its reinforcing role, a conventional tyre-grade carbon black; such a filler is generally characterized, in a known manner, by the presence of hydroxyl (-OH) groups at its surface.

Mineral fillers of the siliceous type, in particular silica (SiO₂), are suitable in particular as reinforcing inorganic fillers. The silica used may be any reinforcing silica known to a person skilled in the art, in particular any precipitated or pyrogenic silica having a BET surface area and a CTAB specific surface area that are both less than 450 m²/g, preferably from 30 to 400 m²/g, in particular between 60 and 300 m²/g. Mention will be made, as highly dispersible precipitated silicas (“HDSs”), for example, of the “Ultrasil” 7000 and “Ultrasil” 7005 silicas from Degussa, the “Zeosil” 1165MP, 1135MP and 1115MP silicas from Rhodia, the “Hi-Sil” EZ150G silica from PPG and the “Zeopol” 8715, 8745 and 8755 silicas from Huber.

In order to couple the reinforcing inorganic filler to the diene elastomer, use is made, in a known manner, of an at least bifunctional coupling agent (or bonding agent) intended to provide a satisfactory connection, of chemical and/or physical nature, between the inorganic filler (surface of its particles) and the diene elastomer. Use is made in particular of at least bifunctional organosilanes or polyorganosiloxanes.

Use is especially made of silane polysulphides, referred to as “symmetrical” or “asymmetrical” depending on their particular structure, as described, for example, in Applications WO 03/002648 (or US 2005/016651) and WO 03/002649 (or US 2005/016650).

Particularly suitable, without the definition below being limiting, are silane polysulphides corresponding to the following general formula (I):

Z-A-Sₓ-A-Z, in which: (I)
x is an integer from 2 to 8 (preferably from 2 to 5);
the A symbols, which are identical or different, represent a divalent hydrocarbon radical (preferably, a C₁-C₁₈ alkylene group or a C₆-C₁₂ arylene group, more particularly a C₁-C₁₀; especially C₁-C₄, alkylene, in particular propylene);
the Z symbols, which are identical or different, correspond to one of the three formulae below:

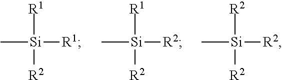

in which:
the R¹ radicals, which are substituted or unsubstituted and identical to or different from one another, represent a C₁-C₁₈ alkyl, C₅-C₁₈ cycloalkyl or C₆-C₁₈ aryl group (preferably, C₁-C₆ alkyl, cyclohexyl or phenyl groups, especially C₁-C₄ alkyl groups, more particularly methyl and/or ethyl);
the R² radicals, which are substituted or unsubstituted and identical to or different from one another, represent a C₁-C₁₈ alkoxyl or C₅-C₁₈ cycloalkoxyl group (preferably a group chosen from C₁-C₈ alkoxyls and C₅-C₈ cycloalkoxyls, more preferably still a group chosen from C₁-C₄ alkoxyls, in particular methoxyl and ethoxyl).

In the case of a mixture of alkoysilane polysulphides corresponding to formula (I) above, especially standard commercially-available mixtures, the average value of “x” is a fractional number preferably between 2 and 5, more preferably close to 4. But the invention may also be advantageously carried out, for example, with disulphide-containing alkoxysilanes (x=2).

Mention will more particularly be made, as examples of silane polysulphides, of bis((C₁-C₄)alkoxyl(C₁-C₄)alkylsilyl(C₁-C₄)alkyl)polysulphides (in particular disulphides, trisulphides or tetrasulphides), such as, for example, bis(3-trimethoxysilylpropyl)polysulphides or bis(3-triethoxysilylpropyl) polysulphides. Use is in particular made, among these compounds, of bis(3-triethoxysilylpropyl)tetrasulphide, abbreviated to TESPT, of formula [(C₂HSO)₃Si(CH₂)₃S₂]₂ or bis(triethoxysilylpropyl) disulphide, abbreviated to TESPD, of formula [(C₂H₅O)₃Si(CH₂)₃S]₂. Mention will also be made, as preferred examples, of bis(mono(C₁-C₄)alkoxyldi(C₁-C₄)alkylsilylpropyl)polysulphides (in particular disulphides, trisulphides or tetrasulphides), more particularly bis(monoethoxydimethylsilylpropyl)tetrasulphide, as described in the aforementioned Patent Application WO 02/083782 (or U.S. Pat. No. 7,217,751).

Mention will especially be made, as examples of coupling agents other than an alkoxysilane polysulphide, of bifunctional POSs (polyorganosiloxanes) or else of hydroxysilane polysulphides (R²═OH in formula I above), such as described, for example, in Patent Applications WO 02/30939 (or U.S. Pat. No. 6,774,255) and WO 02/31041 (or US 2004/051210) and WO 2007/061550, or else of silanes or POSs bearing azodicarbonyl functional groups, such as described, for example, in Patent Applications WO 2006/125532, WO 2006/125533 or WO 2006/125534.

As examples of other silane sulphides, mention will be made, for example, of the silanes bearing at least one thiol (—SH) function (referred to as mercaptosilanes) and/or at least one blocked thiol function, such as described, for example, in Patents or Patent Applications U.S. Pat. No. 6,849,754, WO 99/09036, WO 2006/023815 or WO 2007/098080.

Of course, use could also be made of mixtures of the coupling agents described previously, as described in particular in the aforementioned Application WO 2006/125534.

In the noise-reducing belt-coating rubber, when it is reinforced by an inorganic filler such as silica, the content of coupling agent is preferably between 2 and 15 phr, more preferably between 3 and 12 phr.

A person skilled in the art will understand that, as an equivalent filler to the reinforcing inorganic filler described in the present section, a reinforcing filler of another nature, in particular an organic nature, could be used provided that this reinforcing filler is covered with an inorganic layer, such as silica, or else comprises functional sites, in particular hydroxyl sites, at its surface that require the use of a coupling agent in order to form the bond between the filler and the elastomer.

### 4.1.D. Various Additives

The belt-coating rubber may also comprise all or some of the usual additives customarily used in the rubber compositions for tyres, such as, for example, protective agents such as chemical antiozonants, antioxidants, plasticizing agents or extender oils, whether the latter are of aromatic or non-aromatic nature, in particular non-aromatic or very weakly aromatic oils, for example of naphthenic or paraffinic type, having a high viscosity or preferably having a low viscosity, MES oils, TDAE oils, hydrocarbon plasticizing resins with a high T_{g}, agents facilitating the processing (processability) of the compositions in the uncured state, tackifying resins, reinforcing resins (such as resorcinol or bismaleimide), methylene acceptors or donors such as hexamethylenetetramine or hexamethoxymethylmelamine, a crosslinking system based either on sulphur or on sulphur donors and/or on peroxide and/or on bismaleimides, vulcanization accelerators, vulcanization activators, known adhesion-promoting systems of the metal salt type, for example salts (e.g. acetylacetonates, abietates, naphthenates, tallates) of cobalt, of nickel or of a lanthanide such as neodymium.

In particular, it has emerged that hydrocarbon plasticizing resins with a high T_{g}, preferably above 20° C., more preferably above 30° C. (measured according to ASTM D3418-1999), can advantageously be used since they may make it possible to further improve the technical “sound barrier” effect provided by the belt-coating rubber described above.

Hydrocarbon resins (it is recalled that the designation “resin” is reserved, by definition, to a compound that is solid at 23° C.) are polymers well known to those skilled in the art, which can be used in particular as plasticizing agents or tackifying agents in polymeric matrices. They have been described for example in the work entitled “Hydrocarbon Resins” by R. Mildenberg, M. Zander and G. Collin (New York, VCH, 1997, ISBN 3-527-28617-9), Chapter 5 of which is devoted to their applications, especially in rubber tyres (5.5. “Rubber Tires and Mechanical Goods”). They may be aliphatic, aromatic, of aliphatic/aromatic type, i.e., based on aliphatic and/or aromatic monomers, and may or may not be hydrogenated. They may be natural or synthetic, whether or not based on petroleum (if such is the case, they are also known as petroleum resins). They are preferably exclusively hydrocarbon-based, that is to say that they contain only carbon and hydrogen atoms.

Preferably, their number-average molecular weight (Mₙ) is between 400 and 2000 g/mol, in particular between 500 and 1500 g/mol; their polydispersity index (Iₚ) is preferably less than 3, in particular less than 2 (it should be remembered that Iₚ=M_{w}/Mₙ with M_{w} the weight-average molecular weight). The macrostructure (M_{w}, Mₙ and Iₚ) of the hydrocarbon resin is determined by size exclusion chromatography (“SEC”): tetrahydrofuran solvent; 35° C. temperature; 1 g/l concentration; 1 ml/min flow rate; solution filtered on a filter of 0.45 μm porosity before injection; Moore calibration using polystyrene standards; set of three “WATERS” columns in series (“STYRAGEL” HR4E, HR1 and HR0.5); differential refractometer (“WATERS 2410”) detection and its associated operating software (“WATERS EMPOWER”).

As examples of hydrocarbon plasticizing resins above, mention will especially be made of cyclopentadiene or dicyclopentadiene homopolymer or copolymer resins, terpene homopolymer or copolymer resins, (e.g. α-pinene, β-pinene, dipentene or polylimonene), C₅-cut or C₉-cut homopolymer or copolymer resins, for example C₅-cut/styrene copolymer resins or C₅-cut/C₉-cut copolymer resins.

The content of the hydrocarbon resin is preferably between 5 and 60 phr, in particular between 5 and 50 phr, more preferably still within a range from 10 to 40 phr.

The belt-coating rubber may also contain coupling activators when a coupling agent is used, agents for covering the inorganic filler when an inorganic filler is used, or more generally processing aids capable, in a known manner, owing to an improvement of the dispersion of the filler in the rubber matrix and to a lowering of the viscosity of the compositions, of improving their ability to be processed in the uncured state; these agents are, for example, hydrolysable silanes or hydroxysilanes such as alkylalkoxysilanes, polyols, polyethers, amines or hydroxylated or hydrolysable polyorganosiloxanes.

### 4.1.E. Manufacture of the Compositions

The rubber compositions forming the belt-coating rubber are manufactured in appropriate mixers using, for example, two successive preparation phases according to a general procedure well known to a person skilled in the art: a first phase of thermomechanical working or kneading (sometimes referred to as a “non-productive” phase) at high temperature, up to a maximum temperature of between 130° C. and 200° C., preferably between 145° C. and 185° C., followed by a second phase of mechanical working (sometimes referred to as a “productive” phase) at a lower temperature, typically below 120° C., for example between 60° C. and 100° C., finishing phase during which the crosslinking or vulcanization system is incorporated.

A process that can be used for the manufacture of such rubber compositions comprises, for example, and preferably, the following stages:
in a mixer, incorporating into the diene elastomer or into the mixture of diene elastomers, the high-density filler and the optional other reinforcing filler, everything being kneaded thermomechanically, in one or more steps, until a maximum temperature of between 130° C. and 200° C. is reached;
cooling the combined mixture to a temperature below 100° C.;
subsequently incorporating a crosslinking system;
kneading everything up to a maximum temperature below 120° C.;
extruding or calendering the rubber composition thus obtained.

By way of example, the first (non-productive) phase is carried out in a single thermomechanical stage during which all the necessary constituents, the optional additional covering agents or processing aids, and other various additives, with the exception of the crosslinking system, are introduced into an appropriate mixer, such as a standard internal mixer. After cooling the mixture thus obtained during the first non-productive phase, the crosslinking system is then incorporated, at low temperature, generally in an external mixer, such as an open mill. The combined mixture is then mixed (productive phase) for a few minutes, for example between 5 and 15 min.

The crosslinking system itself is preferably based on sulphur and on a primary vulcanization accelerator, in particular an accelerator of the sulphenamide type. Added to this vulcanization system are various known secondary accelerators or vulcanization activators, such as zinc oxide, stearic acid, guanidine derivatives (in particular diphenylguanidine), etc., incorporated during the first non-productive phase and/or during the productive phase. The sulphur content is preferably between 0.5 and 5 phr and the primary accelerator content is preferably between 0.5 and 8 phr.

Use may be made, as (primary or secondary) accelerator, of any compound capable of acting as accelerator of the vulcanization of diene elastomers in the presence of sulphur, in particular accelerators of the thiazole type and also their derivatives, accelerators of the thiuram and zinc dithiocarbamate types. These accelerators are more preferably selected from the group formed by 2-mercaptobenzothiazyl disulphide (abbreviated to “MBTS”), N-cyclohexyl-2-benzothiazyl sulphenamide (abbreviated to “CBS”), N,N-dicyclohexyl-2-benzothiazyl sulphenamide (“DCBS”), N-tert-butyl-2-benzothiazyl sulphenamide (“TBBS”), N-tert-butyl-2-benzothiazyl sulphenimide (“TBSI”), zinc dibenzyldithiocarbamate (“ZBEC”) and the mixtures of these compounds.

The final composition thus obtained is then calendered, for example in the form of a sheet or a slab, in particular for laboratory characterization, or else is extruded in the form of a rubber profiled element that can be used directly as a coating (or calendering) rubber for textile and/or metallic reinforcers in one or more belt plies.

The vulcanization (or curing) is carried out, in a known manner, at a temperature generally between 130° C. and 200° C., for a sufficient time that may vary, for example, between 5 and 90 min depending in particular on the curing temperature, on the vulcanization system used and on the vulcanization kinetics of the composition in question.

Preferably, the belt-coating rubber has, in the vulcanized state (i.e., after curing), a density that is greater than 1.4 g/cm³, in particular between 1.5 and 3.0 g/cm³. Its secant modulus in extension (denoted by E10) is preferably less than 30 MPa, more preferably between 3 and 30 MPa, in particular within a range from 4 to 20 MPa. This secant modulus in extension (E10) is the tensile modulus measured in a second elongation (i.e., after an accommodation cycle) at 10% elongation (according to ASTM D412-1998; test specimen “C”), this modulus being the “true” secant modulus, i.e., the modulus relative to the actual cross section of the test specimen (standard temperature and relative humidity conditions according to the standard ASTM D 1349-1999).

### 5. EXEMPLARY EMBODIMENT OF THE INVENTION

The rubber composition described previously is therefore used, in the radial tyre of the invention, as a rubber for coating the crown reinforcement or belt placed between the tread and the carcass reinforcement.

It should therefore be understood that this belt-coating rubber may constitute all or part of the rubber matrices coating the textile and/or metallic reinforcers present in the belt itself of the tyre, for example as a coating or calendering rubber for hooping crown plies, protective crown plies or else working crown plies, all constituting said belt.

The thickness of this belt-coating rubber is preferably between 0.1 and 2 mm, in particular in a range from 0.2 to 1.5 mm.

The appended single FIGURE very schematically (in particular not to a specific scale) represents, in radial cross section, an example of a motor vehicle pneumatic tyre having radial carcass reinforcement, in accordance with the invention.

In this FIGURE, the pneumatic tyre (1) shown schematically comprises a crown (2) surmounted by a tread (3) (for simplicity, comprising a very simple tread pattern), two inextensible beads (4) in which a carcass reinforcement (6) is anchored. The crown (2), joined to said beads (4) by two sidewalls (5), is, in a manner known per se, reinforced by a crown reinforcement or “belt” (7) which is at least partly textile and/or metallic and radially external with respect to the carcass reinforcement (6).

More specifically, a tyre belt generally consists of at least two superposed belt plies, sometimes referred to as “working” plies or “crossed” plies, the reinforcing elements or “reinforcers” of which are placed so as to be practically parallel to one another within a ply, but crossed from one ply to the other, that is to say inclined, whether symmetrically or not, relative to the median circumferential plane, by an angle which is generally between 10° and 45° depending on the type of tyre in question. Each of these two crossed plies consists of a rubber matrix referred to sometimes as “calendering rubber” that coats the reinforcers. In the belt, the crossed plies may be finished off by various other plies comprising reinforcers; mention will in particular be made of plies known as “protective” plies, responsible for protecting the rest of the belt from external attack and perforations, or else plies known as “hooping” plies comprising reinforcers oriented substantially along the circumferential direction (plies known as “zero degree” plies), irrespective of whether they are radially outer or inner to the crossed plies.

For the reinforcement of the belts above, in particular of their crossed plies, protective plies or hooping plies, use is generally made of reinforcers in the form of steel cords or textile cords composed of thin wires assembled together by cabling or twisting.

The carcass reinforcement (6) is here anchored into each bead (4) by winding around two bead wires (4a, 4b), the turn-up (6a, 6b) of this reinforcement (6) being for example positioned towards the outside of the tyre (1), which is shown here mounted on its rim (9). The carcass reinforcement (6) is formed from at least one ply reinforced by radial textile cords, that is to say these cords are placed practically parallel to one another and extend from one bead to the other so as to form an angle of between 80° and 90° with the median circumferential plane (plane perpendicular to the axis of rotation of the tyre which is located half way between the two beads 4 and passes through the middle of the crown reinforcement 7). Of course, this tyre (1) additionally comprises, in a known manner, an inner rubber layer (10) (commonly referred to as “inner liner”) that defines the radially inner face of the tyre and that is intended to protect the carcass ply from the diffusion of air coming from the space inside the tyre.

This example of a tyre (1) from the appended FIGURE is characterized in that all or some of the metallic and/or textile reinforcers of the belt (7) are coated, embedded in a rubber matrix (or calendering rubber) consisting of the belt-coating rubber (8) which was described in detail above.

This belt-coating rubber (8) may constitute all or part of the rubbery matrix of one or more fabrics constituting the belt of the tyre of the invention, in particular of a protective crown ply, a hooping crown ply or else, and particularly, working crown plies. By virtue of its improved sound barrier properties, it is capable of helping to reduce the noise emitted both inside and outside vehicles when the tyres are rolling.

1-19. (canceled)

20. A radial tyre for a motor vehicle, the radial tyre comprising:
a crown including at least a tread and a belt;
two inextensible beads;
two sidewalls connecting the two inextensible beads to the tread; and
a carcass reinforcement passing into the two sidewalls and anchored in the two inextensible beads,
wherein the belt is positioned circumferentially between the tread and the carcass reinforcement,
wherein the belt includes textile or metallic reinforcers coated with a belt-coating rubber, and
wherein a composition of the belt-coating rubber includes at least:
a diene elastomer, and
more than 50 phr of a filler of high-density particles having a density of greater than 4 g/cm³.

21. The radial tyre according to claim 20, wherein the diene elastomer is selected from a group that includes: natural rubbers, synthetic polyisoprenes, polybutadienes, butadiene copolymers, isoprene copolymers, and blends thereof.

22. The radial tyre according to claim 21, wherein the composition of the belt-coating rubber includes 50 to 100 phr of a natural rubber or a synthetic polyisoprene.

23. The radial tyre according to claim 20, wherein the composition of the belt-coating rubber includes 0 to 50 phr of at least a second diene elastomer other than a natural rubber or a synthetic polyisoprene.

24. The radial tyre according to claim 23, wherein the second diene elastomer is selected from a group that includes: polybutadienes, butadiene copolymers, and blends thereof.

25. The radial tyre according to claim 22,
wherein a content of the natural rubber or the synthetic polyisoprene is within a range from 50 to 80 phr, and
wherein the composition of the belt-coating rubber includes a second diene elastomer having a content within a range from 20 to 50 phr.

26. The radial tyre according to claim 20, wherein the density of the high-density particles is greater than 4.5 g/cm³.

27. The radial tyre according to claim 26, wherein the density of the high-density particles is greater than 5.0 g/cm³.

28. The radial tyre according to claim 20, wherein the high-density particles are microparticles.

29. The radial tyre according to claim 20, wherein the high-density particles are particles of metal or a metal derivative.

30. The radial tyre according to claim 29, wherein the metal is selected from a group that includes: iron, copper, tin, zinc, tungsten, bismuth, cerium, neodymium, and mixtures thereof.

31. The radial tyre according to claim 29, wherein the high-density particles are particles of metal oxide.

32. The radial tyre according to claim 31, wherein the metal oxide is selected from a group that includes: Fe₂O₃, ZnO, CuO, SnO₂, WO₃, CeO₂, Nd₂O₃, Bi₂O₃, and mixtures thereof.

33. The radial tyre according to claim 20, wherein the high-density particles are in powder form.

34. The radial tyre according to claim 20, wherein the composition of the belt-coating rubber further includes a reinforcing filler.

35. The radial tyre according to claim 34, wherein the reinforcing filler includes silica or carbon black or a mixture of silica and carbon black.

36. The radial tyre according to claim 34, wherein a content of reinforcing filler is between 20 and 100 phr.

37. The radial tyre according to claim 20, wherein a density of the belt-coating rubber, in a vulcanized state, is greater than 1.4 g/cm³.

38. The radial tyre according to claim 37, wherein the density of the belt-coating rubber, in the vulcanized state, is between 1.5 and 3.0 g/cm³.
